(19) United States
(12) Patent Application Publication
(10) Pub. No.: US 2020/0058926 A1
(43) Pub. Date: Feb. 20, 2020

(54) POSITIVE ELECTRODE, BATTERY, BATTERY PACK, ELECTRONIC DEVICE, ELECTRIC VEHICLE, POWER STORAGE DEVICE AND POWER SYSTEM

(71) Applicant: MURATA MANUFACTURING CO., LTD., Kyoto (JP)

(72) Inventors: Takehiro NAKAMARU, Kyoto (JP); Yosuke KOIKE, Kyoto (JP)

(21) Appl. No.: 16/521,998

(22) Filed: Jul. 25, 2019

Related U.S. Application Data
(63) Continuation of application No. PCT/JP2017/038525, filed on Oct. 25, 2017.

(30) Foreign Application Priority Data
Feb. 6, 2017 (JP) 2017-019380

(51) Int. Cl. H01M 4/133; H01G 11/28; H01M 4/66

(52) U.S. Cl. CPC H01M 4/133; H01G 11/28; H01M 10/0525; H01M 4/668; H01M 4/667

(57) ABSTRACT

A battery includes a positive electrode, a negative electrode, and an electrolyte, and the positive electrode contains a melamine-based compound.

### TECHNICAL FIELD

The present technique relates to a positive electrode, a battery, a battery pack, an electronic device, an electric vehicle, an electric storage device, and an electric power system.

### BACKGROUND ART

In recent years, various techniques for improving the safety of a battery are being studied. Proposed is, for example, a technique for improving the safety of a battery by adding an additive to a positive electrode or an electrolytic solution as described below.

Patent Document 1 proposes a technique of adding, to a positive electrode, a halogen element-containing polymer compound (e.g., polyphosphoric acid, ammonium polyphosphate, and sodium polyphosphate) to be capable of maintaining an effect of improving the safety even after charge and discharge cycles and to be capable of lowering an exothermic peak and shifting an exothermic peak temperature to a higher temperature.

Patent Document 2 proposes a technique of adding, to an electrolytic solution, a flame retardant (any of a phosphoric acid ester compound, a phosphorus acid ester compound, and an phosphoric acid ester derivative compound) and an oxidation inhibitor (any of a sulfuric acid ester compound, a sulfuric acid ester compound, and a sulfuric acid ester derivative compound) to be capable of attaining both the flame retardancy and the thermal stability of a lithium ion battery.

### PRIOR ART DOCUMENT

### Patent Documents

Patent Document 1: Japanese Patent Application Laid-Open No. 2010-251217
Patent Document 2: Japanese Patent Application Laid-Open No. 2016-45987

### SUMMARY OF THE INVENTION

### Problem to be Solved by the Invention

An object of the present technique is to provide a positive electrode and a battery that are capable of improving the safety and to provide a battery pack, an electronic device, an electric vehicle, an electric storage device, and an electric power system that each include the battery.

### Means for Solving the Problem

In order to solve the above problem, the battery according to the present technique includes a positive electrode, a negative electrode, and an electrolyte, and the positive electrode contains a melamine-based compound.

The positive electrode according to the present technique contains a melamine-based compound.

The battery pack, the electronic device, the electric vehicle, the electric storage device, and the electric power system according to the present technique each include the battery.

### Advantageous Effect of the Invention

According to the present technique, it is possible to improve the safety of a battery. An effect described here is not necessarily limited, and may be any of effects described in the present disclosure or an effect different from those effects.

### BRIEF EXPLANATION OF DRAWINGS

FIG. 1 is a sectional view illustrating one example of the configuration of a secondary battery according to a first embodiment of the present technique.

FIG. 2 is a sectional view illustrating a partially enlarged wound electrode body illustrated in FIG. 1.

FIG. 3 is an exploded perspective view illustrating one example of the configuration of a secondary battery according to a second embodiment of the present technique.

FIG. 4 is a sectional view of a wound electrode body taken along a line IV-IV in FIG. 3.

FIG. 5 is a block diagram of one example of the configuration of an electronic device as an application example.

FIG. 6 is a schematic diagram illustrating one example of the configuration of an electric storage system in a vehicle as an application example.

FIG. 7 is a schematic diagram illustrating one example of the configuration of an electric storage system in a house as an application example.

FIG. 8A is a graph illustrating DSC curves of positive electrodes according to Examples 2 and 3 and Comparative Example 1. FIG. 8B is a graph illustrating evaluation results of a preservation expansion test for batteries according to Example 7 and Comparative Example 5.

### MODES FOR CARRYING OUT THE INVENTION

Embodiments of the present technique are described in the following order.

1 First embodiment (example of cylindrical battery)
2 Second embodiment (example of laminate film battery)
3 Application example 1 (battery pack and electronic device)
4 Application Example 2 (electric storage system in vehicle)
5 Application example 3 (electric storage system in house)

### 1 First Embodiment

### [Configuration of Battery]

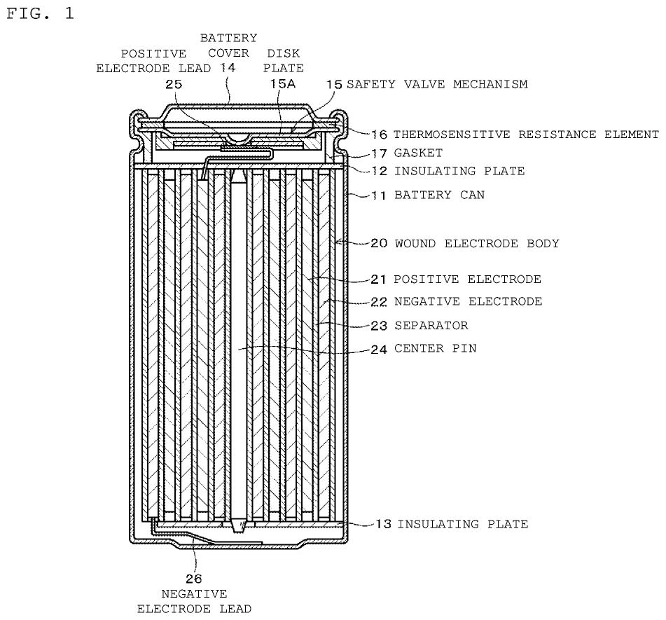

Hereinafter, one exemplary configuration of a secondary battery according to a first embodiment of the present technique is described with reference to FIG. 1. This secondary battery is, for example, a so-called lithium ion secondary battery whose negative electrode capacitance is represented by a capacitance component resulted from occlusion and release of lithium (Li) as an electrode reactant. This secondary battery is a so-called cylindrical secondary battery and includes, in a substantially hollow cylindrical battery can 11, a wound electrode body 20 obtained by stacking and winding a pair of band-shaped positive electrode 21 and band-shaped negative electrode 22, with a separator 23 interposed between the positive electrode and the negative electrode. The battery can 11 is formed of nickel (Ni)-plated iron (Fe), and is closed at one end and is open at the other end. Into the battery can 11, an electrolytic solution as a liquid electrolyte is injected for impregnation of the positive electrode 21, the negative electrode 22, and the separator 23. Further, a pair of insulating plates 12 and 13 is disposed so as to sandwich the wound electrode body 20, in perpendicular to a winding peripheral surface of the wound electrode body.

The battery can 11 is crimped at the open end for attaching, to the open end, a battery cover 14, and a safety valve mechanism 15 and a thermosensitive resistance element (Positive Temperature Coefficient; PTC element) 16 provided in the battery cover 14, with a sealing gasket 17 interposed between the open end and each of the battery cover, the safety valve mechanism, and the thermosensitive resistance element. This configuration allows the battery can 11 to be closely and internally sealed. The battery cover 14 is formed of, for example, the same material as the battery can 11. The safety valve mechanism 15 is electrically connected to the battery cover 14, and allows a disk plate 15A to invert to disconnect the electrical connection between the battery cover 14 and the wound electrode body 20 when an internal short circuit or external heating causes the internal pressure of the battery to reach a certain level or higher. The sealing gasket 17 is formed of, for example, an insulating material and has a surface thereof coated with asphalt.

Into the center of the wound electrode body 20, for example, a center pin 24 is inserted. A positive electrode lead 25 formed of, for example, aluminum (Al) is connected to the positive electrode 21 of the wound electrode body 20, and a negative electrode lead 26 formed of, for example, nickel is connected to the negative electrode 22. The positive electrode lead 25 is welded to the safety valve mechanism 15 to be electrically connected to the battery cover 14, and the negative electrode lead 26 is welded and electrically connected to the battery can 11.

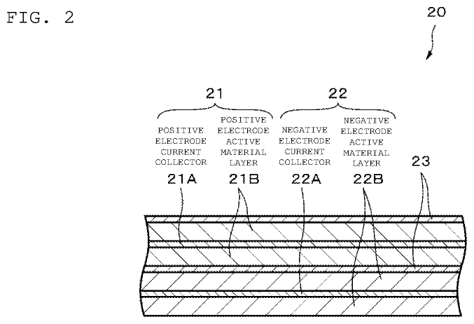

Hereinafter, the positive electrode 21, the negative electrode 22, the separator 23, and the electrolytic solution that constitute the secondary battery are sequentially described with reference to FIG. 2.

### (Positive Electrode)

The positive electrode 21 has, for example, a structure including a positive electrode current collector 21A and a positive electrode active material layer 21B provided on both surfaces of the positive electrode current collector. Although not shown, the positive electrode active material layer 21B may be provided only on one surface of the positive electrode current collector 21A. The positive electrode current collector 21A is formed of, for example, a metal foil such as an aluminum foil, a nickel foil, or a stainless steel foil. The positive electrode active material layer 21B contains, for example, a positive electrode active material (positive electrode material) capable of occluding and releasing lithium as an electrode reactant, and a flame retardant. The positive electrode active material layer 21B may further contain an additive as necessary. As the additive, it is possible to use, for example, at least one of a conductive agent or a binder.

### (Positive Electrode Active Material)

The positive electrode active material is a powder of positive electrode active material particles. As the positive electrode active material capable of occluding and releasing lithium, for example, a lithium-containing compound is appropriate, such as lithium oxide, lithium phosphorus oxide, lithium sulfide, or a lithium-containing intercalation compound, and two or more thereof may be used in mixture. In order to increase the energy density, a lithium-containing compound is preferable that contains lithium, a transition metal element, and oxygen (O). Examples of such a lithium-containing compound include a lithium composite oxide that is represented by Formula (A) and has a layered rock salt structure, and a lithium composite phosphate that is represented by Formula (B) and has an olivine-type structure. The lithium-containing compound more preferably contains, as the transition metal element, at least one of the group consisting of cobalt (Co), nickel, manganese (Mn), and iron. Examples of such a lithium-containing compound include a lithium composite oxide that is represented by Formula (C), Formula (D), or Formula (E) and has a layered rock salt structure, a lithium composite oxide that is represented by Formula (F) and has a spinel-type structure, and a lithium composite phosphate that is represented by Formula (G) and has an olivine-type structure. Specific examples include LiNi_{0.50}Co_{0.20}Mn_{0.30}O₂, LiₐCoO₂ (a≈1), Li_{b}NiO₂ (b≈1), Li_{c1}Ni_{c2}Co_{1-c2}O₂ (c1≈1, 0<c2<1), Li_{d}Mn₂O₄ (d≈1), and LiₑFePO₄ (e≈1).

LiₚNi_{(1-q-r)}Mn_{q}M1ᵣO_{(2-y)}X_{z} (A)

(In Formula (A), M1 represents at least one of elements selected from Groups 2 to 15 except nickel and manganese. X represents at least one of elements in Group 16 except oxygen and elements in Group 17. p, q, y, and z represent values in the ranges of 0≤p≤1.5, 0≤q≤1.0, 0≤r≤1.0, −0.10≤y≤0.20, and 0≤z≤0.2.)

LiₐM2_{b}PO₄ (B)

(In Formula (B), M2 represents at least one of elements selected from Groups 2 to 15. a and b represent values in the ranges of 0≤a≤2.0 and 0.5≤b≤2.0.)

Li_{f}Mn_{(1-g-h)}Ni_{g}M3ₕO₍₂₋ⱼ₎Fₖ (C)

(In Formula (C), M3 represents at least one of the group consisting of cobalt, magnesium (Mg), aluminum, boron (B), titanium (Ti), vanadium (V), chromium (Cr), iron, copper (Cu), zinc (Zn), zirconium (Zr), molybdenum (Mo), tin (Sn), calcium (Ca), strontium (Sr), and tungsten (W). f, g, h, j, and k represent values in the ranges of 0.8≤f≤1.2, 0<g<0.5, 0≤h≤0.5, g+h<1, −0.1≤j≤0.2, and 0≤k≤0.1. The composition of lithium is different depending on the charge and discharge state of the battery and the value f represents a value when the battery is in full discharge.)

LiₘNi₍₁₋ₙ₎M4ₙO₍₂₋ₚ₎F_{q} (D)

(In Formula (D), M4 represents at least one of the group consisting of cobalt, manganese, magnesium, aluminum, boron, titanium, vanadium, chromium, iron, copper, zinc, molybdenum, tin, calcium, strontium, and tungsten. m, n, p, and q represent values in the ranges of 0.8≤m≤1.2, 0.005≤n≤0.5, −0.1≤p≤0.2, and 0≤q≤0.1. The composition of lithium is different depending on the charge and discharge state of the battery and the value m represents a value when the battery is in full discharge.)

LiᵣCo₍₁₋ₛ₎M5ₛO₍₂₋ₜ₎Fᵤ (E)

(In Formula (E), M5 represents at least one of the group consisting of nickel, manganese, magnesium, aluminum, boron, titanium, vanadium, chromium, iron, copper, zinc, molybdenum, tin, calcium, strontium, and tungsten. r, s, t, and u represent values in the ranges of 0.8≤r≤1.2, 0≤s<0.5, −0.1≤t≤0.2, and 0≤u≤0.1. The composition of lithium is different depending on the charge and discharge state of the battery and the value r represents a value when the battery is in full discharge.)

LiᵥMn_{2-w}M6_{w}OₓF_{y} (F)

(In Formula (F), M6 represents at least one of the group consisting of cobalt, nickel, magnesium, aluminum, boron, titanium, vanadium, chromium, iron, copper, zinc, molybdenum, tin, calcium, strontium, and tungsten. v, w, x, and y represent values in the ranges of 0.9≤v≤1.1, 0≤w≤0.6, 3.7≤x≤4.1, and 0≤y≤0.1. The composition of lithium is different depending on the charge and discharge state of the battery and the value v represents a value when the battery is in full discharge.)

Li_{z}M7PO₄ (G)

(In Formula (G), M7 represents at least one of the group consisting of cobalt, manganese, iron, nickel, magnesium, aluminum, boron, titanium, vanadium, niobium (Nb), copper, zinc, molybdenum, calcium, strontium, tungsten, and zirconium. z represents a value in the range of 0.9≤z≤1.1. The composition of lithium is different depending on the charge and discharge state of the battery and the value z represents a value when the battery is in full discharge.)

Other examples of the positive electrode active material capable of occluding and releasing lithium include inorganic compounds containing no lithium, such as MnO₂, V₂O₅, V₆O₁₃, NiS, and MoS.

The positive electrode active material capable of occluding and releasing lithium may also be a compound other than those described above. The positive electrode active materials exemplified above may be mixed in any combination of two or more thereof.

### (Flame Retardant)

The flame retardant covers at least part of surfaces of the positive electrode active material particles. More specifically, the flame retardant partially covers the surfaces of the positive electrode active material particles or covers the entire surfaces of the positive electrode active material particles. From viewpoints of securing the safety of the positive electrode 21 and suppressing the generation of gas, the flame retardant preferably covers the entire surfaces of the positive electrode active material particles.

The flame retardant may be entirely present in the positive electrode active material layer 21B or may be partially present in the positive electrode active material layer 21B. From a viewpoint of improving the safety of the battery, however, the flame retardant is preferably entirely present in the positive electrode active material layer 21B. The concentration distribution of the flame retardant may be constant or varied along the thickness of the positive electrode active material layer 21B.

The flame retardant contains a melamine-based compound. The melamine-based compound contains at least one of melamine or a melamine derivative. From the viewpoint of improving the safety of the battery, the melamine-based compound preferably contains a melamine derivative. From the viewpoint of improving the safety of the battery, the melamine-based compound has a pyrolysis starting temperature of preferably 250° C. or higher, more preferably 300° C. or higher, further more preferably 350° C. or higher.

The pyrolysis starting temperature is determined as follows. A sample to be measured is housed in a sample pan (alumina pan) and a weight curve is acquired using a TG-DTA (Thermogravimetry-Differential Thermal Analysis) device. Thereafter, a weight reduction starting temperature is read that appears in the acquired TG curve.

The melamine derivative is, for example, a melamine compound salt. The melamine compound salt contains, for example, at least one of a simple salt of an inorganic acid and melamine (hereinafter, referred to as a “first inorganic acid salt”), a double salt of an inorganic acid, melamine, melem, and melam (hereinafter, referred to as a “second inorganic acid salt”), or an organic acid salt of an organic acid and melamine.

The first inorganic acid salt preferably contains at least one of melamine borate, melamine polyborate, melamine phosphate, melamine pyrophosphate, melamine metaphosphate, or melamine polyphosphate. Melamine polyphosphate may be cyclic or chain melamine polyphosphate.

The second inorganic acid salt preferably contains at least one of double salts such as melamine melem melam pyrophosphate, melamine melem melam phosphate, melamine melem melam metaphosphate, and melamine melem melam polyphosphate. The double salt melamine melem melam polyphosphate may be a cyclic or chain double salt.

The organic acid salt preferably contains melamine cyanurate.

The flame retardant may contain, in addition to the melamine-based compound, at least one of red phosphorus or a compound represented by the following formula.

### [Chemical 1]

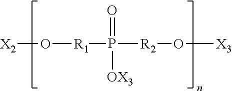

(In the formula, X1, X2, and X3 each represent a melamine-based compound, and R1 and R2 each represent a hydrocarbon group. n represents the degree of polymerization.)

### (Binder)

Used as the binding material is, for example, at least one selected from resin materials such as polyvinylidene difluoride (PVdF), polytetrafluoroethylene (PTFE), polyacrylonitrile (PAN), styrene butadiene rubber (SBR), and carboxymethyl cellulose (CMC), and copolymers containing these resin materials as a main component.

### (Conductive Agent)

The conductive agent is a powder of conductive agent particles. Examples of the conductive agent include carbon materials such as graphite, a carbon fiber, carbon black, ketjen black, and a carbon nanotube. One of these materials may be used alone, or two or more of these materials may be used in mixture. In addition to the carbon materials, a material that has conductivity may be used, such as a metal material or a conductive polymer material.

### (Negative Electrode)

The negative electrode 22 has, for example, a structure including a negative electrode current collector 22A and a negative electrode active material layer 22B provided on both surfaces of the negative electrode current collector. Although not shown, the negative electrode active material layer 22B may be provided only on one surface of the negative electrode current collector 22A. The negative electrode current collector 22A is formed of, for example, a metal foil such as a copper foil, a nickel foil, or a stainless steel foil.

The negative electrode active material layer 22B contains one or two or more negative electrode active materials capable of occluding and releasing lithium. The negative electrode active material layer 22B may further contain an additive such as a binder or a conductive agent as necessary.

This secondary battery preferably includes the negative electrode 22 or the negative electrode active material having a larger electrochemical equivalent than the electrochemical equivalent of the positive electrode 21 to theoretically allow no deposition of lithium metal on the negative electrode 22 during the charge.

### (Negative Electrode Active Material)

Examples of the negative electrode active material include carbon materials such as non-graphitizable carbon, graphitizable carbon, graphite, pyrolytic carbons, cokes, glassy carbons, an organic polymer compound fired body, a carbon fiber, and activated carbon. Among these carbon materials, the cokes include, for example, pitch coke, needle coke, and petroleum coke. The organic polymer compound fired body refers to a product obtained by carbonizing a polymer material such as a phenol resin or a furan resin through firing at an appropriate temperature, and some of such products are classified into non-graphitizable carbon or graphitizable carbon. These carbon materials are preferable because they have much less change in the crystal structure caused during the charge and discharge to enable the battery to obtain a high charge and discharge capacitance and good cycle characteristics. Particularly, graphite is preferable because it has a large electrochemical equivalent to enable the battery to obtain a high energy density. Further, non-graphitizable carbon is preferable because it enables the battery to obtain excellent cycle characteristics. Furthermore, a material that is low in charge and discharge potential, specifically a material that has a charge and discharge potential close to the charge and discharge potential of lithium metal is preferable because it enables the battery to easily attain a high energy density.

Examples of another negative electrode active material that enables the battery to have a high capacitance include a material containing at least one of a metal element or a metalloid element as a constituent element (for example, an alloy, a compound, or a mixture). This is because the use of such a material enables the battery to obtain a high energy density. Particularly, the use of such a material together with a carbon material is more preferable because it enables the battery to obtain a high energy density and excellent cycle characteristics. In the present technique, the alloy includes not only one formed of two or more metal elements but also one formed of one or more metal elements and one or more metalloid elements. Further, the alloy may contain a non-metal element. The alloy includes, as its structure, a solid solution, a eutectic crystal (eutectic mixture), an intermetallic compound, or two or more thereof in coexistence.

Examples of such a negative electrode active material include a metal element or a metalloid element capable of forming an alloy with lithium. Specific examples include magnesium, boron, aluminum, titanium, gallium (Ga), indium (In), silicon (Si), germanium (Ge), tin, lead (Pb), bismuth (Bi), cadmium (Cd), silver (Ag), zinc, hafnium (Hf), zirconium, yttrium (Y), palladium (Pd) and platinum (Pt). These elements may be crystalline or amorphous.

As the negative electrode active material, a material is preferable that contains, as a constituent element, a metal element in Group 4B of the short periodic table or a metalloid element, and a material is more preferable that contains at least one of silicon or tin as a constituent element. This is because silicon and tin are high in ability of occluding and releasing lithium to enable the battery to obtain a high energy density. Examples of such a negative electrode active material include a simple substance, an alloy, or a compound of silicon, a simple substance, an alloy, or a compound of tin, and a material that at least partially has a phase of one or two or more thereof.

Examples of the alloy of silicon include a silicon alloy containing, as a second constituent element other than silicon, at least one of the group consisting of tin, nickel, copper, iron, cobalt, manganese, zinc, indium, silver, titanium, germanium, bismuth, antimony (Sb), and chromium. Examples of the alloy of tin include a tin alloy containing, as a second constituent element other than tin, at least one of the group consisting of silicon, nickel, copper, iron, cobalt, manganese, zinc, indium, silver, titanium, germanium, bismuth, antimony, and chromium.

Examples of the compound of tin or the compound of silicon include a tin or silicon compound containing oxygen or carbon, and the tin or silicon compound may contain, in addition to tin or silicon, the second constituent element described above.

Above all, the Sn-based negative electrode active material is preferably a SnCoC-containing material that contains cobalt, tin, and carbon as constituent elements, and has a carbon content of 9.9 mass % or more and 29.7 mass % or less and a proportion of cobalt in the total of tin and cobalt of 30 mass % or more and 70 mass % or less. This is because the Sn-based negative electrode active material in such a composition range enables the battery to obtain a high energy density and excellent cycle characteristics.

This SnCoC-containing material may further contain another constituent element as necessary. Preferable as the other constituent element is, for example, silicon, iron, nickel, chromium, indium, niobium, germanium, titanium, molybdenum, aluminum, phosphorus (P), gallium, or bismuth, and the SnCoC-containing material may contain two or more thereof. This is because such a SnCoC-containing material enables the battery to further improve the capacitance or the cycle characteristics.

This SnCoC-containing material has a phase containing tin, cobalt, and carbon, and this phase preferably has a low crystallinity or amorphous structure. In this SnCoC-containing material, carbon as the constituent element is preferably at least partially bonded to a metal element or a metalloid element as another constituent element. This is because deterioration of the cycle characteristics is considered to be caused by aggregation or crystallization of, for example, tin, and the bonding of carbon to another element makes it possible to suppress such aggregation or crystallization.

Examples of a measurement method of examining the bonding state of elements include X-ray photoelectron spectroscopy (XPS). In the XPS, the carbon is orbital (Cis) peak of graphite appears at 284.5 eV when a device is used that has been adjusted for energy calibration to give the gold atom 4f orbital (Au4f) peak at 84.0 eV. The peak of surface-contaminated carbon appears at 284.8 eV. In contrast, when the carbon element has a higher charge density, for example, when carbon is bonded to a metal element or a metalloid element, the C1s peak appears in a lower region than 284.5 eV. That is, when the C1s synthetic wave peak of the SnCoC-containing material appears in a lower region than 284.5 eV, carbon contained in the SnCoC-containing material is at least partially bonded to a metal element or a metalloid element as another constituent element.

The XPS measurement uses, for example, the C1s peak for correction of the energy axis of the spectrum. Since the surface-contaminated carbon is generally present on the surface, the C1s peak of the surface-contaminated carbon is set at 284.8 eV, which is regarded as reference energy. In the XPS measurement, the waveform of the C1s peak is obtained as a waveform including the peak of the surface-contaminated carbon and the peak of the carbon in the SnCoC-containing material, and therefore, the peak of the surface-contaminated carbon is separated from the peak of the carbon in the SnCoC-containing material through analysis with use of, for example, commercially available software. In analysis of the waveform, the position of the main peak present on the lowest binding energy side is set as the reference energy (284.8 eV).

Examples of another negative electrode active material include a metal oxide or a polymer compound capable of occluding and releasing lithium. Examples of the metal oxide include lithium titanium oxide containing titanium and lithium, such as lithium titanate (Li₄Ti₅O₁₂); iron oxide; ruthenium oxide; and molybdenum oxide. Examples of the polymer compound include polyacetylene, polyaniline, and polypyrrole.

### (Binder)

Used as the binder is, for example, at least one selected from resin materials such as polyvinylidene difluoride, polytetrafluoroethylene, polyacrylonitrile, a styrene butadiene rubber, and carboxymethyl cellulose, and copolymers containing these resin materials as a main component.

### (Conductive Agent)

As the conductive agent, it is possible to use the same carbon materials as for the positive electrode active material layer 21B

### (Separator)

The separator 23 isolates the positive electrode 21 from the negative electrode 22 to prevent a current short circuit caused by contact between both the electrodes and lets lithium ions pass therethrough. The separator 23 is formed of, for example, a porous film made from a resin such as polytetrafluoroethylene, polypropylene, or polyethylene, and may have a structure obtained by stacking these two or more porous films. Above all, a polyolefin porous film is preferable because it has an excellent short circuit-prevention effect and is capable of improving the safety of the battery by its shutdown effect. Particularly, polyethylene is preferable as a material for constituting the separator 23 because it is capable of giving a shutdown effect in the range of 100° C. or higher and 160° C. or lower and is excellent in electrochemical stability. Besides these materials, it is possible to use a material obtained by copolymerizing or blending a chemically stable resin with polyethylene or polypropylene. Alternatively, the porous film may have a three or more layer structure obtained by sequentially stacking a polypropylene layer, a polyethylene layer, and polypropylene layer.

The separator 23 may be configured to include a base material and a surface layer provided on one or both surfaces of the base material. The surface layer contains electrically insulating inorganic particles and a resin material that binds the inorganic particles to the surface of the base material and binds the inorganic particles to each other. This resin material may have, for example, a three-dimensional network structure formed through continuous interconnection of fibrils into which the resin material is formed. The resin material having this three-dimensional network structure supports the inorganic particles, allowing the inorganic particles not to be connected to each other and thus enabling the inorganic particles to maintain a dispersed state. Alternatively, the resin material may bind the surface of the base material and the inorganic particles to each other without being formed into fibrils. This case enables the resin material to obtain a higher binding property. The surface layer provided on one or both surfaces of the base material as described above is capable of imparting the oxidation resistance, the heat resistance, and the mechanical strength to the base material.

The base material is a porous layer having porosity. More specifically, the base material is a porous film formed of an insulating film having a high ion permeability and a predetermined mechanical strength, and holds the electrolytic solution in its pores. While having a predetermined mechanical strength as a main part of the separator, the base material preferably requires characteristics such as high resistance to the electrolytic solution, low reactivity, and a property of being less likely to be expanded.

As a resin material constituting the base material, it is preferable to use, for example, a polyolefin resin such as polypropylene or polyethylene, an acrylic resin, a styrene resin, a polyester resin, or a nylon resin. Particularly, polyethylene such as low-density polyethylene, high-density polyethylene, or linear polyethylene, low molecular-weight wax thereof, or a polyolefin resin such as polypropylene is appropriately used because these materials have an appropriate melting temperature and are readily available. Alternatively, the base material may have a structure obtained by stacking two or more porous films of these materials or may be a porous film formed by melting and kneading two or more of these resin materials. The base material that includes a porous film formed of a polyolefin resin has excellent separability between the positive electrode 21 and the negative electrode 22 and is capable of further promoting the reduction of the internal short circuit.

As the base material, a nonwoven fabric may be used. As a fiber constituting the nonwoven fabric, it is possible to use, for example, an aramid fiber, a glass fiber, a polyolefin fiber, a polyethylene terephthalate (PET) fiber, or a nylon fiber. Alternatively, two or more of these fibers may be mixed to form the nonwoven fabric.

The inorganic particles contain, for example, at least one of a metal oxide, a metal nitride, a metal carbide, or a metal sulfide. As the metal oxide, it is possible to suitably use, for example, aluminum oxide (alumina, Al₂O₃), boehmite (hydrated aluminum oxide), magnesium oxide (magnesia, MgO), titanium oxide (titania, TiO₂), zirconium oxide (zirconia, ZrO₂), silicon oxide (silica, SiO₂), or yttrium oxide (yttria, Y₂O₃). As the metal nitride, it is possible to suitably use, for example, silicon nitride (Si₃N₄), aluminum nitride (AlN), boron nitride (BN), or titanium nitride (TiN). As the metal carbide, it is possible to suitably use, for example, silicon carbide (SiC) or boron carbide (B4C). As the metal sulfide, it is possible to suitably use, for example, barium sulfate (BaSO₄). Further, minerals may also be used, for example, a porous aluminosilicate such as a zeolite (M_{2/n}O.Al₂O₃.xSiO₂.yH₂O, M is a metal element, x≥2, y≥0); a layered silicate; barium titanate (BaTiO₃); or strontium titanate (SrTiO₃). Above all, it is preferable to use alumina, titania (particularly, titania having a rutile-type structure), silica, or magnesia, and it is more preferable to use alumina. The inorganic particles have the oxidation resistance and the heat resistance, and the inorganic particle-containing surface layer on the side opposite to the positive electrode also has strong resistance to an oxidizing environment near the positive electrode during the charge. The shape of the inorganic particles is not particularly limited, and it is possible to use any of spherical, plate-like, fibrous, cubic, and random shapes.

Examples of the resin material constituting the surface layer include fluorine-containing resins such as polyvinylidene difluoride and polytetrafluoroethylene; fluorine-containing rubbers such as a vinylidene fluoride-tetrafluoroethylene copolymer and an ethylene-tetrafluoroethylene copolymer; rubbers such as a styrene-butadiene copolymer or a hydrogenated product thereof, an acrylonitrile-butadiene copolymer or a hydrogenated product thereof, an acrylonitrile-butadiene-styrene copolymer or a hydrogenated product thereof, a methacrylic acid ester-acrylic acid ester copolymer, a styrene-acrylic acid ester copolymer, an acrylonitrile-acrylic acid ester copolymer, an ethylene propylene rubber, polyvinyl alcohol, and polyvinyl acetate; cellulose derivatives such as ethyl cellulose, methyl cellulose, hydroxyethyl cellulose, and carboxymethyl cellulose; and resins having at least one of a melting point or a glass transition temperature of 180° C. or higher to have high heat resistance, such as polyphenylene ether, polysulfone, polyethersulfone, polyphenylene sulfide, polyether imide, polyimide, a polyamide, e.g., a wholly aromatic polyamide (aramid), polyamide imide, polyacrylonitrile, polyvinyl alcohol, polyether, an acrylic acid resin, and polyester. These resin materials may be used alone, or two or more thereof may be used in mixture. Above all, fluorine-based resins such as polyvinylidene difluoride are preferable from viewpoints of the oxidation resistance and the flexibility, and the surface layer preferably contains aramid or polyamide imide from a viewpoint of the heat resistance.

The inorganic particles preferably have a particle size in the range of 1 nm to 10 μm. The inorganic particles having a particle size of less than 1 nm are not readily available, and requires disproportionate costs even when being available. On the other hand, the inorganic particles having a particle size of more than 10 μm increases the distance between the electrodes, not allowing a sufficient filling amount of the active material in a limited space to decrease the battery capacitance.

As a method of forming the surface layer, it is possible to use, for example, a method of applying onto the base material (porous film) a slurry containing a matrix resin, a solvent, and an inorganic substance, and letting the base material pass through a bath containing a poor solvent for the matrix resin and the above solvent as a good solvent for the matrix resin to cause phase separation and thereafter drying the base material.

The inorganic particles may be contained in the porous film as the base material. The surface layer may be formed of only the resin material without containing the inorganic particles.

### (Electrolytic Solution)

The separator 23 is impregnated with the electrolytic solution as a liquid electrolyte. The electrolytic solution contains a solvent and an electrolyte salt dissolved in this solvent. The electrolytic solution may contain a known additive to improve the battery characteristics.

As the solvent, it is possible to use a cyclic carbonic acid ester such as ethylene carbonate or propylene carbonate, and it is preferable to use one of ethylene carbonate or propylene carbonate, particularly preferable to use both ethylene carbonate and propylene carbonate in mixture. This is because such a solvent enables the battery to improve the cycle characteristics.

As the solvent, it is preferable to use these cyclic carbonic acid esters in mixture with a chain carbonic acid ester such as diethyl carbonate, dimethyl carbonate, ethyl methyl carbonate, or methyl propyl carbonate. This is because such a solvent enables the electrolytic solution to have a high ionic conductivity.

The solvent preferably further contains 2,4-difluoroanisole or vinylene carbonate. This is because 2,4-difluoroanisole is capable of improving the discharge capacitance of the battery and vinylene carbonate is capable of improving the cycle characteristics of the battery. Accordingly, the mixture use of these compounds is preferable because it enables the battery to improve the discharge capacitance and the cycle characteristics.

In addition to these compounds, examples of the solvent include butylene carbonate, γ-butyrolactone, γ-valerolactone, 1,2-dimethoxyethane, tetrahydrofuran, 2-methyltetrahydrofuran, 1,3-dioxolane, 4-methyl-1,3-dioxolane, methyl acetate, methyl propionate, acetonitrile, glutaronitrile, adiponitrile, methoxyacetonitrile, 3-methoxypropionitrile, N,N-dimethylformamide, N-methylpyrrolidinone, N-methyloxazolidinone, N,N-dimethylimidazolidinone, nitromethane, nitroethane, sulfolane, dimethylsulfoxide, and trimethyl phosphate.

Compounds obtained by at least partially substituting hydrogen of these nonaqueous solvents with fluorine are sometimes preferable because the compounds are sometimes capable of improving the reversibility of an electrode reaction depending on the types of electrodes in combination.

Examples of the electrolyte salt include a lithium salt, and one electrolyte salt may be used alone, or two or more electrolyte salts may be used in mixture. Examples of the lithium salt include LiPF₆, LiBF₄, LiAsF₆, LiClO₄, LiB(C₆H₅)₄, LiCH₃SO₃, LiCF₃SO₃, LiN (SO₂CF₃)₂, LiC (SO₂CF₃)₃, LiAlCl₄, LiSiF₆, LiCl, difluoro[oxolato-O,O′] lithium borate, lithium bis(oxalate)borate, and LiBr. Above all, LiPF₆ is preferable because it enables the electrolytic solution to obtain a high ionic conductivity and enables the battery to improve the cycle characteristics.

### [Potential of Positive Electrode]

The potential (vs Li/Li⁺) of the positive electrode in full charge of the battery is preferably 4.30 V or more, more preferably 4.35 V or more, further more preferably 4.40 V or more. The potential (vs Li/Li⁺) of the positive electrode in full charge of the battery, however, may be less than 4.30 V (for example, 4.2 V or 4.25 V). An upper limit value of the potential (vs Li/Li⁺) of the positive electrode in full charge of the battery is not particularly limited but is preferably 6.00 V or less, more preferably 4.60 V or less, further more preferably 4.50 V or less.

### [Operation of Battery]

When a nonaqueous electrolyte secondary battery configured as described above is charged, a lithium ion is released from the positive electrode active material layer 21B and occluded by the negative electrode active material layer 22B through the electrolytic solution, for example. When the nonaqueous electrolyte secondary battery is discharged, a lithium ion is released from the negative electrode active material layer 22B and occluded by the positive electrode active material layer 21B through the electrolytic solution, for example.

### [Method of Manufacturing Battery]

Next described is one example of the method of manufacturing the secondary battery according to the first embodiment of the present technique.

First, a positive electrode mixture is prepared by mixing, for example, a positive electrode material, a flame retardant, a conductive agent, and a binder, and a pasty positive electrode mixture slurry is produced by dispersing this positive electrode mixture in a solvent such as N-methyl-2-pyrrolidone (NMP). Next, this positive electrode mixture slurry is applied to the positive electrode current collector 21A, the solvent is dried, and the positive electrode current collector is subjected to compression molding with, for example, a roll pressing machine, to form the positive electrode active material layer 21B and thus form the positive electrode 21.

Meanwhile, a negative electrode mixture is prepared by mixing, for example, a negative electrode active material with a binder, and a pasty negative electrode mixture slurry is produced by dispersing this negative electrode mixture in a solvent such as N-methyl-2-pyrrolidone. Next, this negative electrode mixture slurry is applied to the negative electrode current collector 22A, the solvent is dried, and the negative electrode current collector is subjected to compression molding with, for example, a roll pressing machine to form the negative electrode active material layer 22B and thus produce the negative electrode 22.

Next, the positive electrode lead 25 is attached to the positive electrode current collector 21A by, for example, welding, and the negative electrode lead 26 is attached to the negative electrode current collector 22A by, for example, welding. Next, the positive electrode 21 and the negative electrode 22 are wound, with the separator 23 interposed between the positive electrode and the negative electrode. Next, a tip of the positive electrode lead 25 is welded to the safety valve mechanism 15, a tip of the negative electrode lead 26 is welded to the battery can 11, and the wound positive electrode 21 and negative electrode 22 are sandwiched between the pair of insulating plates 12 and 13 and housed in the battery can 11. Next, the electrolytic solution is injected into the battery can 11 to impregnate the separator 23, after the positive electrode 21 and the negative electrode 22 are housed in the battery can 11. Next, the battery can 11 is crimped at the opening end for fixing, to the opening end, the battery cover 14, the safety valve mechanism 15, and the thermosensitive resistance element 16, with the sealing gasket 17 interposed between the opening end and each of the battery cover, the safety valve mechanism, and the thermosensitive resistance element. These procedures give the secondary battery illustrated in FIG. 1.

### Effects

In the battery according to the first embodiment, because the positive electrode 21 contains the melamine-based compound, it is possible to improve the thermal stability of the positive electrode 21 (battery). Accordingly, it is possible to improve the safety of the battery.

Further, when the melamine-based compound covers at least part of the surfaces of the positive electrode active material particles, it is possible to suppress a reaction between the positive electrode active material and the electrolytic solution on the surfaces of the positive electrode active material particles. Further, when oxygen is generated in the positive electrode active material layer 21B due to decomposition of the electrolytic solution, the melamine-based compound attracts the generated oxygen. Accordingly, it is possible to suppress the amount of gas generated due to decomposition of the electrolytic solution during the charge and discharge of the battery.

### Modified Example

The first embodiment has described about the preparation of the positive electrode mixture by mixing the positive electrode material, the flame retardant, the conductive agent, and the binder. The preparation of the positive electrode mixture, however, may be performed by mixing the positive electrode material, the conductive agent, and the binder after at least part of the surface of the positive electrode material is covered with the flame retardant.

### 2 Second Embodiment

### [Configuration of Battery]

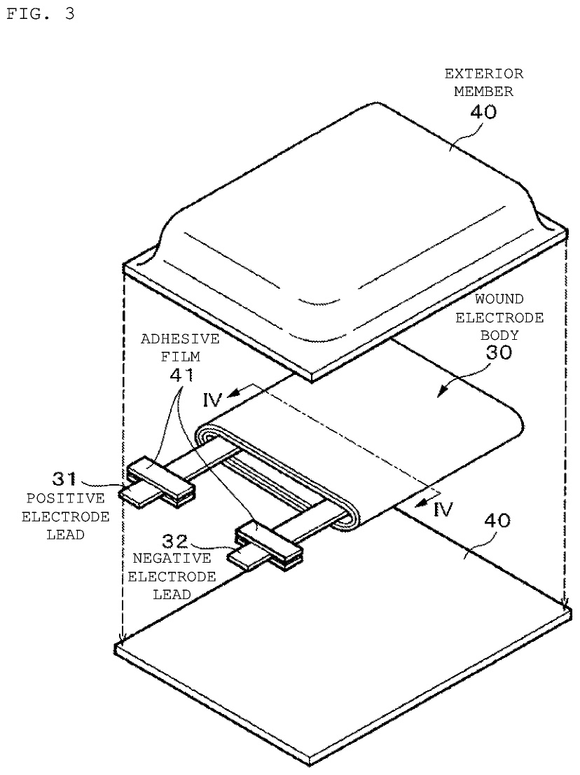

FIG. 3 is an exploded perspective view illustrating one exemplary configuration of a secondary battery according to a second embodiment of the present technique. This secondary battery is a so-called flattened or rectangular battery that is obtained by housing, in a film-shaped exterior member 40, a wound electrode body 30 having a positive electrode lead 31 and a negative electrode lead 32 attached thereto and that is capable of attaining the reduction in size, weight, and thickness.

Each of the positive electrode lead 31 and the negative electrode lead 32 goes from the inside toward the outside of the exterior member 40 and is, for example, led out toward an identical direction. Each of the positive electrode lead 31 and the negative electrode lead 32 is formed of, for example, a metal material such as aluminum, copper, nickel, or stainless steel and is supposed to be thin plate-shaped or net-shaped.

The exterior member 40 is formed of, for example, a rectangular aluminum laminate film obtained by bonding a nylon film, an aluminum foil, and a polyethylene film in this order. The exterior member 40 is provided, for example, such that the polyethylene film side thereof is opposite to the wound electrode body 30, and outer edges of the exterior member are attached firmly to each other by fusion bonding or with an adhesive. Between the exterior member 40 and each of the positive electrode lead 31 and the negative electrode lead 32, an adhesive film 41 for preventing the intrusion of outside air is inserted. The adhesive film 41 is formed of a material having adhesiveness to the positive electrode lead 31 and the negative electrode lead 32, for example, a polyolefin resin such as polyethylene, polypropylene, modified polyethylene, or modified polypropylene.

The exterior member 40 may be formed of a laminate film having another structure, a polymer film such as polypropylene, or a metal film, in place of the aluminum laminate film. Alternatively, a laminate film may be used that includes an aluminum film as a core material, and a polymer film stacked on one or both surfaces of the aluminum film.

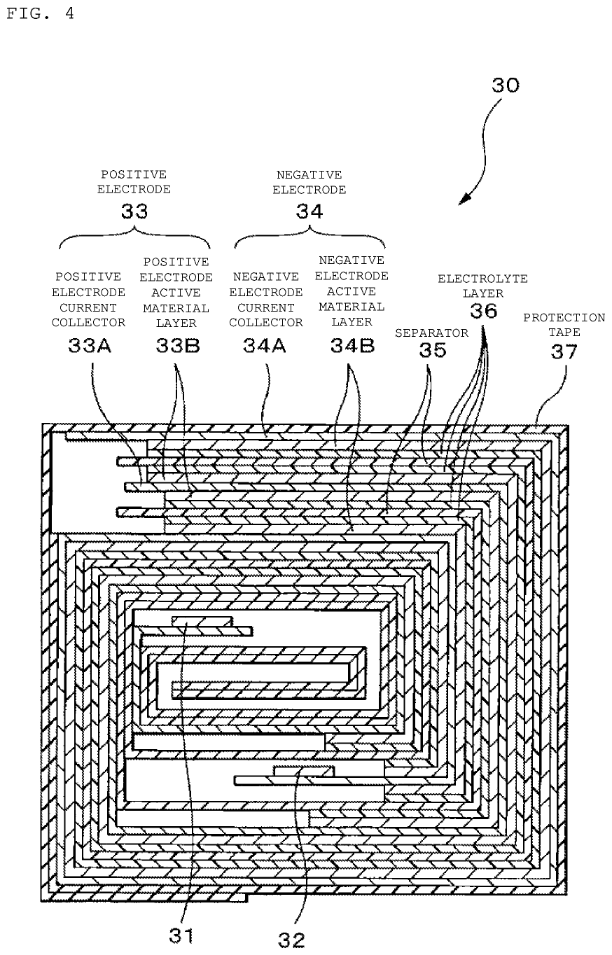

FIG. 4 is a sectional view taken along a line IV-IV of the wound electrode body 30 illustrated in FIG. 3. The wound electrode body 30 is obtained by stacking and winding a positive electrode 33 and a negative electrode 34, with a separator 35 and an electrolyte layer 36 interposed between the positive electrode and the negative electrode, and is protected at the outermost peripheral portion by a protection tape 37.

The positive electrode 33 has a structure including a positive electrode current collector 33A and a positive electrode active material layer 33B provided on one or both surfaces of the positive electrode current collector. The negative electrode 34 has a structure including a negative electrode current collector 34A and a negative electrode active material layer 34B provided on one or both surfaces of the negative electrode current collector, and the negative electrode active material layer 34B and the positive electrode active material layer 33B are disposed so as to be opposite to each other. The configurations of the positive electrode current collector 33A, the positive electrode active material layer 33B, the negative electrode current collector 34A, the negative electrode active material layer 34B, and the separator 35 are the same as the positive electrode current collector 21A, the positive electrode active material layer 21B, the negative electrode current collector 22A, the negative electrode active material layer 22B, and the separator 23 in the first embodiment.

The electrolyte layer 36 contains an electrolytic solution and a polymer compound as a holding body for holding this electrolytic solution, and is a so-called gel. The gelled electrolyte layer 36 is preferable because it is capable of obtaining a high ionic conductivity and preventing liquid leakage from the battery. The electrolytic solution is the electrolytic solution of the first embodiment. Examples of the polymer compound include polyacrylonitrile, polyvinylidene difluoride, a copolymer of vinylidene fluoride and hexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, a polyacrylic acid, a polymethacrylic acid, a styrene-butadiene rubber, a nitrile-butadiene rubber, polystyrene, and polycarbonate. Particularly, polyacrylonitrile, polyvinylidene difluoride, polyhexafluoropropylene, or polyethylene oxide is preferable in terms of electrochemical stability.

The gelled electrolyte layer 36 may contain the same inorganic substance as described for the resin layer of the separator 23 in the first embodiment. This is because the inorganic substance is capable of further improving the heat resistance. Alternatively, an electrolytic solution may be used in place of the electrolyte layer 36.

### [Method of Manufacturing Battery]

Next described is one example of the method of manufacturing the secondary battery according to the second embodiment of the present technique.

First, a precursor solution containing a solvent, an electrolyte salt, a polymer compound, and a mixed solvent is applied to the positive electrode 33 and the negative electrode 34, and the mixed solvent is volatilized to form the electrolyte layer 36. Next, the positive electrode lead 31 is attached to an end of the positive electrode current collector 33A by welding, and the negative electrode lead 32 is attached to an end of the negative electrode current collector 34A by welding. Next, the positive electrode 33 and the negative electrode 34 each having the electrolyte layer 36 formed thereon were stacked, with the separator 35 interposed between the positive electrode and the negative electrode, to form a stacked body, and this stacked body is wound longitudinally and bonded at the outermost peripheral portion with the protection tape 37 to form the wound electrode body 30. Last, the wound electrode body 30 is, for example, held in the exterior member 40, and the outer edges of the exterior member 40 were attached firmly by thermal fusion bonding to seal the wound electrode body in the exterior member. In sealing, the adhesive film 41 is inserted between each of the positive electrode lead 31 and the negative electrode lead 32, and the exterior member 40. These procedures give the secondary battery illustrated in FIGS. 4 and 4.

Alternatively, this secondary battery may be produced as follows. First, the positive electrode 33 and the negative electrode 34 are produced as described above, and the positive electrode lead 31 and the negative electrode lead 32 are attached to the positive electrode 33 and the negative electrode 34, respectively. Next, the positive electrode 33 and the negative electrode 34 are stacked and wound, with the separator 35 interposed between the positive electrode and the negative electrode, and are bonded at the outermost peripheral portion with the protection tape 37 to form a wound body. Next, this wound body is held in the exterior member 40, and the outer edges except one side of the exterior member are attached to each other by thermal fusion bonding to form a bag and thus allow the wound body to be housed in the exterior member 40. Next, an electrolyte composition is prepared that contains a solvent, an electrolyte salt, a monomer as a raw material for a polymer compound, and a polymerization initiator as well as another material such as a polymerization inhibitor as necessary, and the electrolyte composition is injected into the exterior member 40.

Next, the opening of the exterior member 40 is hermetically sealed by thermal fusion bonding in a vacuum atmosphere after the electrolyte composition is injected into the exterior member 40. Next, the exterior member is heated to polymerize the monomer to give the polymer compound and thus form the gelled electrolyte layer 36. The procedures described above give the secondary battery illustrated in FIG. 4.

### Effects

In the battery according to the first embodiment, because the positive electrode 33 contains the melamine-based compound, it is possible to improve the safety of the battery as in the first embodiment.

Further, when the melamine-based compound covers at least part of the surfaces of the positive electrode active material particles, the battery is, as in the first embodiment, capable of reducing the amount of gas generated due to decomposition of the electrolytic solution during the charge and discharge of the battery. Accordingly, it is possible to suppress the expansion of the battery.

### 3 Application Example 1

### “Battery Pack and Electronic Device as Application Example”

Application Example 1 describes a battery pack including the battery according to the first or second embodiment, and an electronic device.

### [Configuration of Battery Pack and Electronic Device]

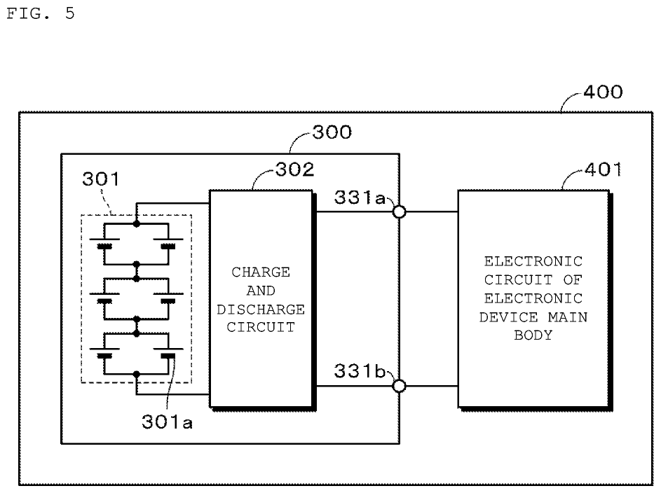

Hereinafter, one exemplary configuration of a battery pack 300 and an electronic device 400 is described as an application example with reference to FIG. 5. The electronic device 400 includes an electronic circuit 401 of an electronic device main body, and the battery pack 300. The battery pack 300 is electrically connected to the electronic circuit 401 via a positive electrode terminal 331a and a negative electrode terminal 331b. The electronic device 400 is, for example, configured to allow the user to freely detach the battery pack 300. The configuration of the electronic device 400 is not limited to this detachable configuration, and the electronic device 400 may be configured to include a built-in battery pack 300 so as not to allow the user to remove the battery pack 300 from the electronic device 400.

The positive electrode terminal 331a and the negative electrode terminal 331b of the battery pack 300 are, during the charge of the battery pack 300, connected to a positive electrode terminal and a negative electrode terminal of a charger (not shown), respectively. On the other hand, the positive electrode terminal 331a and the negative electrode terminal 331b of the battery pack 300 are, during the discharging of the battery pack 300 (during the use of the electronic device 400), connected to a positive electrode terminal and a negative electrode terminal of the electronic circuit 401, respectively.

Examples of the electronic device 400 include but are not limited to: a notebook personal computer, a tablet computer, a mobile phone (for example, a smartphone), a handheld terminal (Personal Digital Assistants: PDA), a display device (for example, an LCD, an EL display, and electronic paper), an imaging device (for example, a digital still camera and a digital video camera), an audio instrument (for example, a portable audio player), a game machine, a cordless phone handset, an electronic book, an electronic dictionary, a radio, a headphone, a navigation system, a memory card, a pacemaker, a hearing aid, an electric tool, an electric shaver, a refrigerator, an air conditioner, a television, a stereo, a water heater, a microwave oven, a dishwasher, a washing machine, a drier, a lighting device, a toy, a medical device, a robot, a road conditioner, and a traffic light.

### (Electronic Circuit)

The electronic circuit 401 includes, for example, a CPU, a peripheral logic unit, an interface unit, and a storage unit, and controls the overall electronic device 400.

### (Battery Pack)

The battery pack 300 includes an assembled battery 301 and a charge and discharge circuit 302. The assembled battery 301 is configured to have a plurality of secondary batteries 301a connected in series and/or in parallel. The plurality of secondary batteries 301a are connected to form, for example, an arrangement of n batteries in parallel and m batteries in series (n and m are positive integers). FIG. 5 illustrates an example of the connection of six secondary batteries 301a in an arrangement of two batteries in parallel and three batteries in series (2P3S). As the secondary battery 301a, the battery according to the first or second embodiment is used.

Here, the battery pack 300 is described that includes the assembled battery 301 formed of the plurality of secondary batteries 301a. The battery pack 300, however, may employ a configuration including one secondary battery 301a in place of the assembled battery 301.

The charge and discharge circuit 302 is a control unit that controls the charge and discharge of the assembled battery 301. Specifically, the charge and discharge circuit 302 controls the charge of the assembled battery 301 during the charge. On the other hand, the charge and discharge circuit 302 controls the discharge of the assembled battery for the electronic device 400 during the discharge (that is, during the use of the electronic device 400).

### 4 Application Example 2

### “Electric Storage System in Vehicle as Application Example”

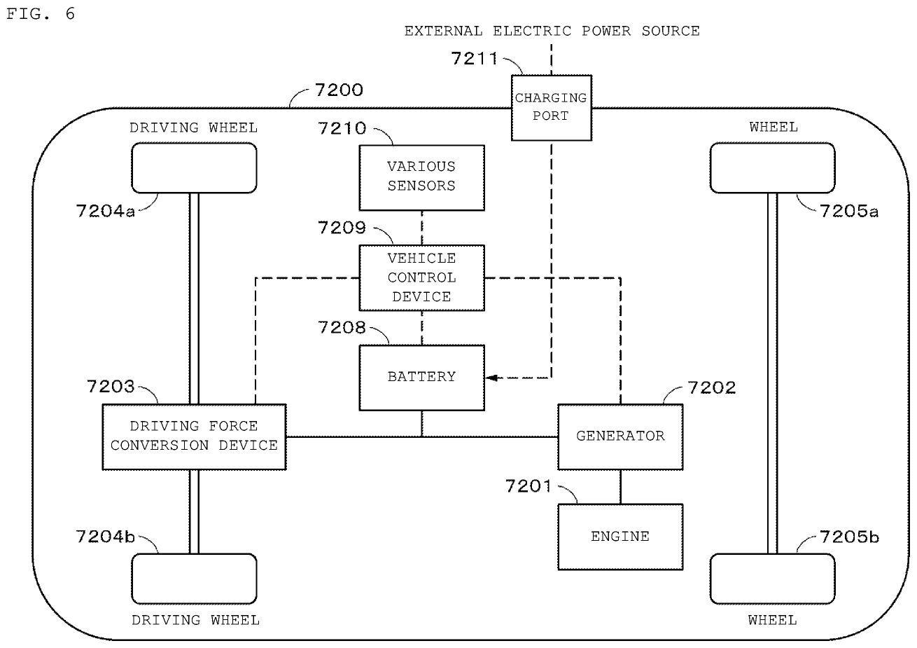

An example of applying the present disclosure to an electric storage system for a vehicle is described with reference to FIG. 6. FIG. 6 schematically illustrates one example of the configuration of a hybrid vehicle that employs a series hybrid system to which the present disclosure is applied. The series hybrid system is a vehicle that runs on an electric power-driving force conversion device, using the electric power generated by an engine-driven generator or the electric power generated by the engine-driven generator and once stored in a battery.

A hybrid vehicle 7200 carries an engine 7201, a generator 7202, an electric power-driving force conversion device 7203, a driving wheel 7204a, a driving wheel 7204b, a wheel 7205a, a wheel 7205b, a battery 7208, a vehicle control device 7209, various sensors 7210, and a charging port 7211. The above-described electric storage device according to the present disclosure is applied to the battery 7208.

The hybrid vehicle 7200 runs using the electric power-driving force conversion device 7203 as a power source. A motor is one example of the electric power-driving force conversion device 7203. The electric power-driving force conversion device 7203 is operated by the electric power of the battery 7208, and the torque of this electric power-driving force conversion device 7203 is transmitted to the driving wheels 7204a and 7204b. The electric power-driving force conversion device 7203 that includes direct current-alternate current (DC-AC) or reverse conversion (AC-DC conversion) in a necessary location thereof is applicable as both an alternate-current motor and a direct-current motor. The various sensors 7210 control the engine speed via the vehicle control device 7209 and control the position (throttle position) of a throttle valve (not shown). The various sensors 7210 include, for example, a speed sensor, an acceleration sensor, and an engine speed sensor.

The torque of the engine 7201 is transmitted to the generator 7202, and it is possible to store, in the battery 7208, the electric power generated by the generator 7202 through the torque.

When the hybrid vehicle is decelerated by a braking mechanism (not shown), the resistance force during the deceleration is applied as torque to the electric power-driving force conversion device 7203 to allow the electric power-driving force conversion device 7203 to generate, by this torque, regenerative electric power, which is stored in the battery 7208.

The battery 7208 is connected to an electric power source outside the hybrid vehicle to be capable of receiving supply of electric power from the outside electric power source, with the charging port 211 used as an input port, and thus to be capable of storing the received electric power.

Although not shown, the hybrid vehicle may include an information processor that performs information processing related to the control of the vehicle, on the basis of information on the secondary battery. Examples of such an information processor include an information processor that displays the remaining battery level on the basis of information on the remaining battery level.

In the foregoing, described as an example is the series hybrid vehicle that runs on the motor, using the electric power generated by the engine-driven generator or the electric power generated by the engine-driven generator and once stored in the battery. The present disclosure, however, is effectively applicable also to a parallel hybrid vehicle that applies the output power of both the engine and the motor as a driving source, and that is used while appropriately switched among three systems of running only on the engine, running only on the motor, and running on the engine and the motor. Further, the present disclosure is effectively applicable also to a so-called electric vehicle that runs on driving only by a driving motor without any engine.

In the foregoing, one example of the hybrid vehicle 7200 has been described to which the technique according to the present disclosure is applicable. The technique according to the present disclosure is suitably applicable to the battery 7208 among the configurations described above.

### 5 Application Example 3

### “Electric Storage System in House as Application Example”

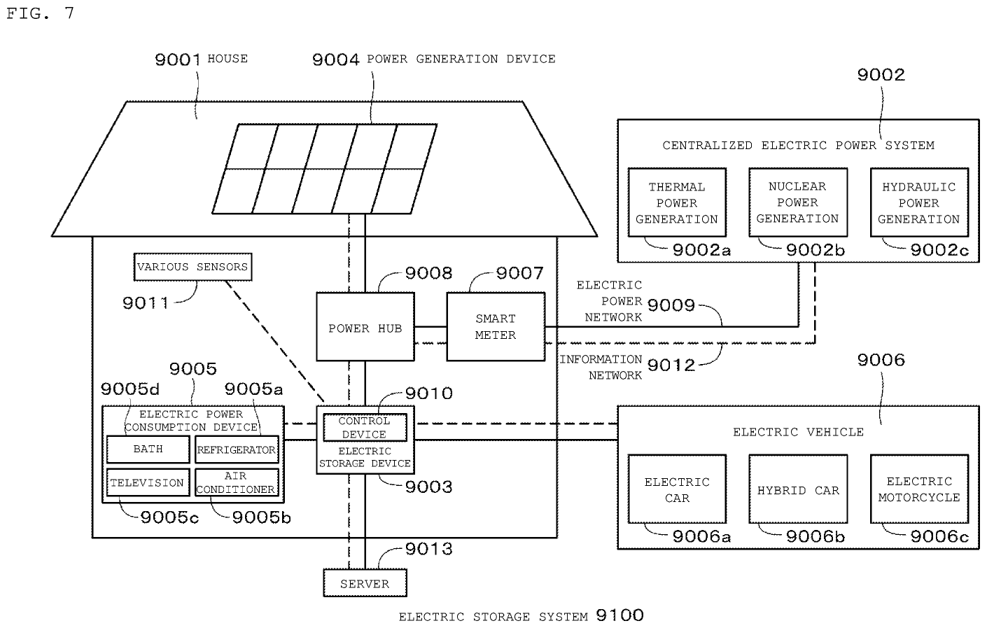

An example of applying the present disclosure to an electric storage system for a house is described with reference to FIG. 7. For example, in an electric storage system 9100 for a house 9001, electric power is supplied, to an electric storage device 9003, from a centralized electric power system 9002 such as thermal power generation 9002a, nuclear power generation 9002b, or hydraulic power generation 9002c via, for example, an electric power network 9009, an information network 9012, a smart meter 9007, and a power hub 9008. At the same time, electric power is supplied to the electric storage device 9003 from an independent electric power source such as a home power generation device 9004. The electric storage device 9003 stores the supplied electric power. Electric power for use in the house 9001 is fed by the electric storage device 9003. The same electric storage system is usable not only for the house 9001 but also for a building.

The house 9001 includes the power generation device 9004, an electric power consumption device 9005, the electric storage device 9003, a control device 9010 for controlling the devices, the smart meter 9007, and sensors 9011 for acquiring various types of information. The devices are connected to each other by the electric power network 9009 and the information network 9012. Used as the power generation device 9004 is, for example, a solar battery or a fuel battery, and the generated electric power is supplied to the electric power consumption device 9005 and/or the electric storage device 9003. The electric power consumption device 9005 includes, for example, a refrigerator 9005a, an air conditioner 9005b, a television receiver 9005c, and a bath 9005d. The electric power consumption device 9005 further includes an electric vehicle 9006. The electric vehicle 9006 includes an electric car 9006a, a hybrid car 9006b, and an electric motorcycle 9006c.

The above-described battery unit according to the present disclosure is applied to the electric storage device 9003. The electric storage device 9003 is formed of a secondary battery or a capacitor. For example, the electric storage device is formed of a lithium ion battery. The lithium ion battery may be stationary or may be one used in the electric vehicle 9006. The smart meter 9007 has a function of measuring the usage of commercial electric power and transmitting the measured usage to an electric power company. The electric power network 9009 may be any one or a combination of direct-current power feeding, alternate-current power feeding, and contactless power feeding.

The various sensors 9011 are, for example, a human sensor, an illuminance sensor, an object detection sensor, an electric power consumption sensor, a vibration sensor, a contact sensor, a temperature sensor, and an infrared sensor. Information acquired by the various sensors 9011 is transmitted to the control device 9010. The information from the sensors 9011 makes the control device recognize, for example, a weather state and a human state, so that the control device automatically controls the electric power consumption device 9005 to be capable of minimizing the energy consumption. Further, the control device 9010 is capable of transmitting information on the house 9001 to, for example, an external electric power company via the Internet.

The power hub 9008 performs processing such as electric power line branching and DC-AC conversion. Examples of a communication method of the information network 9012 connected to the control device 9010 include a method of using a communication interface such as a UART (Universal Asynchronous Receiver-Transmitter: transmission and reception circuit for asynchronous serial communication), and a method of using a sensor network in accordance with a wireless communication standard such as Bluetooth (registered trademark), ZigBee, or Wi-Fi. The Bluetooth system, which is applied to multimedia communication, is capable of performing one-to-many connection communication. The ZigBee uses the IEEE (Institute of Electrical and Electronics Engineers) 802.15.4 as a physical layer. The IEEE 802.15.4 is a name of a short range wireless network standard referred to as PAN (Personal Area Network) or W (Wireless) PAN.

The control device 9010 is connected to an external server 9013. This server 9013 may be managed by any of the house 9001, an electric power company, and a service provider. The information transmitted and received by the server 9013 is, for example, electric power consumption information, life pattern information, electric power charge, weather information, natural disaster information, and information on an electric power trade. These pieces of information may be transmitted and received from the electric power consumption device (for example, a television receiver) in the home, but may be transmitted and received from a device (for example, a mobile phone) outside the home. These pieces of information may be displayed on a device that has a display function, for example, a television receiver, a mobile phone, or a PDA (Personal Digital Assistants).

The control device 9010 that controls the units is formed of, for example, a CPU (Central Processing Unit), a RAM (Random Access Memory), and a ROM (Read Only Memory). In this example, the control device is stored in the electric storage device 9003. The control device 9010 is connected to the electric storage device 9003, the home power generation device 9004, the electric power consumption device 9005, the various sensors 9011, and the server 9013 via the information network 9012, and has a function of adjusting, for example, the usage of commercial electric power and the amount of power generation. Further, the control unit may also have, for example, a function of handling an electric power trade in an electric power market.

As described above, the electric storage device 9003 is capable of storing electric power generated not only by the centralized electric power system 9002 such as the thermal power 9002a, the nuclear power 9002b, or the hydraulic power 9002c, but also by the home power generation device 9004 (solar power generation and wind power generation). Accordingly, even when the home power generation device 9004 fluctuates in generated power, it is possible to perform control of keeping a regular level of exteriorly sent electric power or control of the discharge only for as much the electric power as needed. This electric storage system enables, for example, a method of storing the electric power obtained by solar power generation in the electric storage device 9003, storing cheap night-time electric power in the electric storage device 9003 at night, and using the electric power stored in the electric storage device 9003 for the discharge in the daytime during which the electric power is expensive.

This example has described about the storage of the control device 9010 in the electric storage device 9003. The control device, however, may be stored in the smart meter 9007 or may be configured alone. Further, the electric storage system 9100 may be used for a plurality of homes in a residential complex or may be used for a plurality of detached houses.

In the foregoing, one example of the electric storage system 9100 has been described to which the technique according to the present disclosure is applicable. The technique according to the present disclosure is suitably applicable to the secondary battery included in the electric storage device 9003 among the configurations described above.

### EXAMPLES

Hereinafter, the present technique is specifically described by way of examples, but is not to be limited to only these examples.

The examples and comparative examples are described in the following order.

i Examples and comparative examples for evaluating thermal stability of positive electrode
ii Example and comparative example for evaluating preservation expansion of battery

### i Examples and Comparative Examples for Evaluating Thermal Stability of Positive Electrode

### Examples 1 to 3

First, a positive electrode mixture was prepared by mixing lithium cobalt composite oxide (LiCoO₂) as a positive electrode active material, an amorphous carbon powder (ketjen black) as a conductive agent, polyvinylidene difluoride (PVdF) as a binder, melamine melam melem polyphosphate (double salt) (melamine: 50%, melam: 40%, melem: 10%) as a flame retardant at a mass ratio shown in Table 1. Next, the positive electrode mixture was mixed with an appropriate amount of NMP (N-methyl-2-pyrrolidone) and kneaded with a planetary centrifugal mixer for dispersion to give a slurry positive electrode mixture coating material. Subsequently, this positive electrode mixture coating material was applied to a 12-μm-thick aluminum foil, dried at 100° C., pressed with a hand pressing machine to give a volume density of 4.1 g/cc, and vacuum-dried, to produce a band-shaped positive electrode.

### Examples 4 to 6

A positive electrode was produced in the same manner as in Example 1 except that melamine cyanurate, melamine borate, or melamine polyphosphate was used as the flame retardant, and the materials (the positive electrode active material, the conductive agent, the binder, and the flame retardant) were mixed at a mass ratio shown in Table 1 to prepare a positive electrode mixture.

### Comparative Example 1

A positive electrode was produced in the same manner as in Example 1 except that no flame retardant was used, and the materials (the positive electrode active material, the conductive agent, and the binder) except the flame retardant were mixed at a mass ratio shown in Table 1 to prepare a positive electrode mixture.

### Comparative Examples 2 to 4

A positive electrode was produced in the same manner as in Example 1 except that a condensed phosphoric acid ester, phenylphosphonic acid, or a phenolic antioxidant (tetrakis methane) was used as the flame retardant, and the materials (the positive electrode active material, the conductive agent, the binder, and the flame retardant) were mixed at a mass ratio shown in Table 1 to prepare a positive electrode mixture.

### (Evaluation of Thermal Stability)

### [Production of First Coin Cell]

First coin cells were produced as follows, using the positive electrodes obtained as described above. First, each of the positive electrodes according to Examples 1 to 6 and Comparative Examples 1 to 4 was punched in circle to produce a pellet-shaped positive electrode.

Next, ethylene carbonate (EC) and propylene carbonate (PC) was mixed at a volume ratio of EC:PC=1:1 to prepare a mixed solvent, and then 3 mass % of fluoroethylene carbonate (4-fluoro-1,3-dioxolan-2-one: FEC) was added to this mixed solvent. Subsequently, lithium hexafluorophosphate (LiPF₆) as an electrolyte salt was dissolved in this mixed solvent at a concentration of 1 M to prepare a nonaqueous electrolytic solution. Thereafter, a 2016-size coin cell was produced using the positive electrode as a working electrode, 1-mm-thick Li metal as a counter electrode, 5-μm-thick polyethylene fine porous film as a separator, and the nonaqueous electrolytic solution as an electrolyte.

### [Production of Second Coin Cell]

A second coin cell was produced as follows. A negative electrode was produced as follows. First, a negative electrode mixture was prepared by mixing 95.3 mass % of a mixture of Si and graphite as a negative electrode active material, 1.7 mass % of an amorphous carbon powder (ketjen black) as a conductive agent, and 3.0 mass % of PVdF as a negative electrode binder. Next, the negative electrode mixture was mixed with an appropriate amount of NMP and kneaded with a planetary centrifugal mixer for dispersion to give a slurry negative electrode mixture coating material. Subsequently, this negative electrode mixture coating material was applied to a 12-μm-thick copper foil, dried at 120° C., pressed with a hand pressing machine to give a volume density of 1.9 g/cc, and vacuum-dried, to produce a band-shaped alloy/graphite mixture negative electrode. Thereafter, this negative electrode was punched in circle to produce a pellet-shaped negative electrode.

The second coin cell was produced in the same manner as the first coin cell except that the negative electrode was used as the working electrode.

### [Charge and Discharge]

First, the first and second coin cells were charged and discharged under the following charge conditions.

First Coin Cell

1st to 2nd cycle charge: CCCV (Constant Current/Constant Voltage) charge 0.1 CCCV-4.40 V, 0.025 Ccut

1st to 2nd cycle discharge: CC (Constant Current) discharge 0.1 C-3.0 Vcut

3rd cycle charge: CCCV charge 0.35 CCCV 4.40 V-6 hcut

Second Coin Cell

1st to 2nd cycle charge: CCCV charge 0.08 CCCV-0 V, 0.025 Ccut

1st to 2nd cycle discharge: CC discharge 0.1 C-1.5 Vcut

3rd cycle charge: CCCV charge 0.35 CCCV 0 V-13 hcut

### [DSC Analysis]

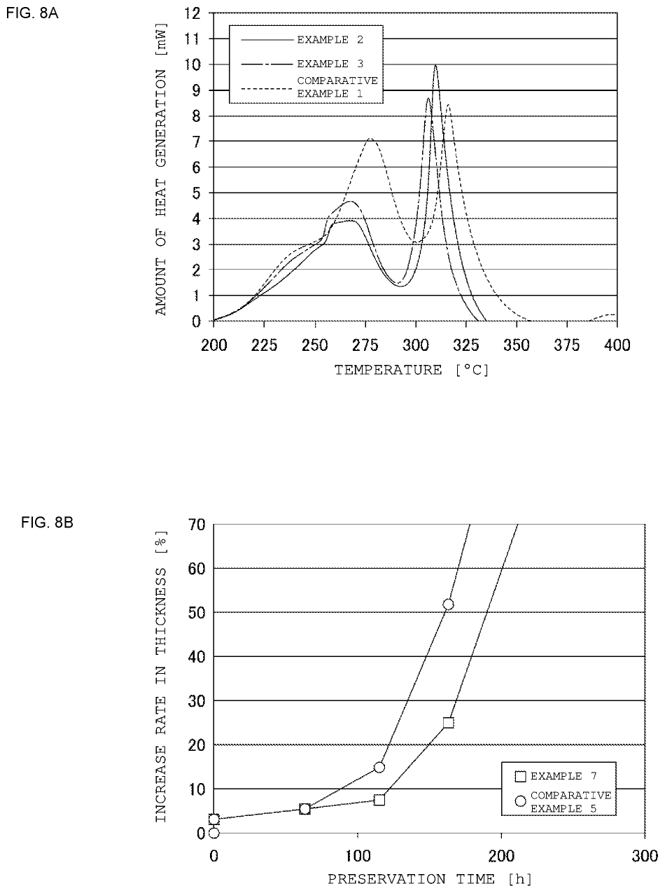

Next, the first and second coin cells were disassembled, the positive electrode and the negative electrode in charge were extracted, and then, a 5-μm-thick polyethylene fine porous film as a separator was interposed between the positive electrode and the negative electrode, to produce a counter electrode sample. Subsequently, this counter electrode sample was housed in a sample pan (gold-plated sus-pan), and a DSC curve was obtained using a DSC analyzer at a temperature rise rate of 20° C./min. From the DSC curve of each of the obtained samples, a maximum value at a peak (2nd peak) closest to 270° C. was determined. Table 1 shows the results. FIG. 8A illustrates the DSC curves of the positive electrodes according to Examples 2 and 3 and Comparative Example 1.

### [SEM Observation]

Surfaces of the positive electrodes (positive electrode active material layers) according to Examples 1 to 6 were observed using a scanning electron microscope (SEM). The observation resulted in clarifying that the melamine-based compound (melamine melam melem polyphosphate (double salt), melamine cyanurate, melamine borate, or melamine polyphosphate) covered surfaces of positive electrode active material particles. A reason why only the addition of the melamine-based compound to the positive electrode mixture enables the melamine-based compound to cover the surfaces of the positive electrode active material particles as described above is considered to be due to relatively high affinity of the melamine-based compound to the positive electrode active material (e.g., LCO).

Table 1 shows the configurations and the evaluation results of the positive electrodes according to Examples 1 to 6 and Comparative Examples 1 to 4.

TABLE 1

| | | | Flame | | | | | |
|---|---|---|---|---|---|---|---|---|
| | | | retardant | | | | | DSC |
| | | | pyrolysis | Composition ratio | | | | exothermic |
| | Type of material | | starting | Active | Flame | Conductive | | peak |
| | Active | | temperature | material | retardant | agent | PVdF | 2nd |
| | material | Flame retardant | (°) | (mass %) | (mass %) | (mass %) | (mass %) | (mW) |
| Example 1 | LiCoO₂ | Melamine melam melem polyphosphate | 400 | 94.00 | 2.00 | 2.00 | 2.00 | 3.6 |
| | | (double salt) | | | | | | |
| Example 2 | | Melamine melam melem polyphosphate | 400 | 95.80 | 0.20 | 2.00 | 2.00 | 4.22 |
| | | (double salt) | | | | | | |
| Example 3 | | Melamine melam melem polyphosphate | 400 | 95.97 | 0.03 | 2.00 | 2.00 | 4.89 |
| | | (double salt) | | | | | | |
| Example 4 | | Melamine cyanurate | 300 | 95.00 | 1.00 | 2.00 | 2.00 | 4.83 |
| Example 5 | | Melamine borate | 200 | 94.00 | 2.00 | 2.00 | 2.00 | 6.06 |
| Example 6 | | Melamine polyphosphate | 250 | 94.00 | 2.00 | 2.00 | 2.00 | 5.55 |
| Comparative | | None | — | 96.00 | 0.00 | 2.00 | 2.00 | 8.52 |
| Example 1 | | | | | | | | |
| Comparative | | Condensed phosphoric acid ester | 275 | 94.00 | 2.00 | 2.00 | 2.00 | 6.5 |
| Example 2 | | | | | | | | |
| Comparative | | Phenylphosphonic acid | 160 | 94.00 | 2.00 | 2.00 | 2.00 | 7.12 |
| Example 3 | | | | | | | | |
| Comparative | | Phenolic antioxidant (tetrakis methane) | 250 | 95.00 | 1.00 | 2.00 | 2.00 | 6.97 |
| Example 4 | | | | | | | | |

Table 1 and FIG. 8A clarify the following matters.

The positive electrode that contains melamine melam melem polyphosphate (double salt) is capable of suppressing the amount of heat generation of about 300° C. or lower. More specifically, the use of the positive electrode containing a melamine derivative enables a decrease in the maximum value of the peak closest to 270° C. Further, it is possible to decrease the maximum value of the peak closest to 270° C. along with an increase in content of the melamine derivative in the positive electrode. Accordingly, it is possible to suppress a temperature rise of the battery due to a thermal runaway.

In a nail penetration test, rapid generation of heat is generally more likely to occur along with an increase in the capacitance value and the charge voltage value of the battery. Judging from the results of the DSC measurement, however, the positive electrode that contains melamine melem melam polyphosphate (double salt) is assumed to be capable of increasing the upper limit voltage for nail penetration.

During the thermal runaway, the positive electrode active material is damaged due to a temperature rise of the battery, and oxygen is released. Melamine melem melam polyphosphate (double salt) has a function of trapping an oxygen radical and is capable of attracting oxygen released from the positive electrode to suppress spread of flame. Further, melamine, melam, and melem are decomposed to be capable of generating a large amount of nitrogen gas and thus diluting the concentration of oxygen.

The above-described effects are capable of improving the thermal stability of the battery (positive electrode) and thus improving the safety of the battery. The positive electrode that contains a melamine-based compound such as melamine cyanurate, melamine borate, or melamine polyphosphate is also capable of giving the same types of effects as the positive electrode that contains melamine melam melem polyphosphate (double salt). From the viewpoint of improving the safety, however, melamine melam, melem polyphosphate (double salt) is preferable among the above-described melamine-based compounds.

When a melamine-based compound other than those described in the examples is used, such as melamine polyborate, melamine phosphate, melamine pyrophosphate, melamine metaphosphate, melamine melem melam pyrophosphate (double salt), melamine melem melam phosphate (double salt), or melamine melem melam metaphosphate (double salt), it is also possible to obtain the effect of improving the safety as in the cases of using the melamine-based compounds described in the examples.

### ii Example and Comparative Example for Evaluating Preservation Expansion of Battery

### Example 7

### [Production of Positive Electrode]

A band-shaped positive electrode was produced in the same manner as in Example 2.

### [Production of Negative Electrode]

A band-shaped negative electrode was produced in the same manner as in the second coin cell.

### [Production of Secondary Battery]

A laminate film lithium ion secondary battery was produced as follows. First, an aluminum positive electrode lead was welded to a positive electrode current collector, and a copper negative electrode lead was welded to a negative electrode current collector. Subsequently, the produced positive electrode and negative electrode were attached firmly to each other, with a 5-μm-thick polyethylene fine porous film as a separator interposed between the positive electrode and the negative electrode, and were wound longitudinally to form a wound body, and then, a protection tape was attached to an outermost peripheral portion of the wound body to produce a flattened wound electrode body. Next, this wound electrode body was loaded in an exterior member whose three sides were thermally fusion-bonded but whose one side was not thermally fusion-bonded to allow the exterior member to have an opening. As the exterior member, a moisture-proof aluminum laminate film was used that was obtained by stacking a 25-μm-thick nylon film, a 40-μm-thick aluminum foil, a 30-μm-thick polypropylene film in this order from the outermost layer. Thereafter, a nonaqueous electrolytic solution was prepared that was prepared in the same manner as in the first coin cell, this electrolytic solution was injected into the exterior member through the opening, and the one remaining side of the exterior member was thermally fusion-bonded for hermetical sealing under a reduced pressure. These procedures gave the intended laminate film lithium ion secondary battery.

### Comparative Example 5

A laminate film lithium ion secondary battery was obtained in the same manner as in Example 7 except that a band-shaped positive electrode was used that was produced in the same manner as in Comparative Example 1.

### (Preservation Expansion Test)

The laminate film lithium ion secondary battery was preserved in a 50° C. atmosphere while a voltage of 55 mV was applied to the battery, and the rate of increase (%) in thickness of the battery between before and after the preservation was determined. FIG. 8B shows the results.

FIG. 8B clarifies that the coverage of the surfaces of the positive electrode active material particles with melamine melem melam polyphosphate (double salt) enables a decrease in the amount of gas generated due to decomposition of the electrolytic solution during the charge and discharge of the battery, resulting in suppressing the preservation expansion of the battery.

When a melamine-based compound other than those described in the examples is used, such as melamine borate, melamine polyborate, melamine phosphate, melamine pyrophosphate, melamine metaphosphate, melamine polyphosphate, melamine melem melam pyrophosphate (double salt), melamine melem melam phosphate (double salt), or melamine melem melam metaphosphate (double salt), it is also possible to obtain the effect of suppressing the expansion of the battery as in the cases of using the melamine-based compounds described in the examples.

In the foregoing, the embodiments and the examples of the present technique have been specifically described. The present technique, however, is not limited to the embodiments and the examples, and it is possible to implement various modifications based on a technical idea of the present technique.

For example, the configurations, the methods, the steps, the shapes, the materials, the values, and the like described in the embodiments and the examples are no more than examples, and a configuration, a method, a step, a shape, a material, a value, and the like may be employed that are different from these examples, as necessary.

Further, it is possible to combine the configurations, the methods, the steps, the shapes, the materials, the values, and the like in the embodiments and the examples, without departing from the spirit of the present technique.

The embodiments and the examples have described about the cases of applying the present technique to the cylindrical battery and the laminate film secondary battery. The shape of the battery, however, is not particularly limited. It is possible to apply the present technique to, for example, a rectangular or coin-type secondary battery. It is also possible to apply the present technique to, for example, a flexible battery mounted on a wearable terminal such as a smartwatch, a head mount display, or iGlass (registered trademark).

The embodiments and the examples have described about the cases of applying the present technique to the wound second battery and the stacked secondary battery. The structure of the battery, however, is not limited to these structures, and the present technique is also applicable to, for example, a secondary battery having a structure including the positive electrode and the negative electrode that are folded.

The embodiments and the examples have described about the cases of applying the present technique to the lithium ion secondary battery and the lithium ion polymer secondary battery. The type of the battery to which the present technique is applicable is not limited to these types of batteries. For example, the present technique is also applicable to, for example, a bulk all-solid-state battery.

The embodiments and the examples have described about the case of the electrode configured to include the current collector and the active material layer. The configuration of the electrode, however, is not limited to this configuration. For example, the electrode may be configured to include only the active material layer.

The present technique is also capable of employing the following configurations.

(1)

A battery including a positive electrode, a negative electrode, and an electrolyte,

the positive electrode containing a melamine-based compound.

(2)

The battery according to (1), in which the melamine-based compound contains at least one of melamine or a melamine derivative.

(3)

The battery according to (1) or (2), in which the melamine-based compound is a melamine compound salt.

(4)

The battery according to (3), in which the melamine compound salt contains an inorganic acid salt of an inorganic acid and melamine.

(5)

The battery according to (4), in which the inorganic acid salt is at least one of melamine borate, melamine polyborate, melamine phosphate, melamine pyrophosphate, melamine metaphosphate, or melamine polyphosphate.

(6)

The battery according to (3), in which the melamine compound salt contains an inorganic acid salt of an inorganic acid, melamine, melem, and melam.

(7)

The battery according to (6), in which the inorganic acid salt is at least one of double salts such as melamine melem melam pyrophosphate, melamine melem melam phosphate, melamine melem melam metaphosphate, and melamine melem melam polyphosphate.

(8)

The battery according to (3), in which the melamine compound salt contains an organic acid salt of an organic acid and melamine.

(9)

The battery according to (8), in which the organic acid salt is melamine cyanurate.

(10)

The battery according to any of (1) to (9), in which the melamine-based compound has a pyrolysis starting temperature of 250° C. or higher.

(11)

The battery according to any of (1) to (10), in which

the positive electrode contains positive electrode active material particles, and

the melamine-based compound covers at least part of surfaces of the positive electrode active material particles.

(12)

The battery according to any of (1) to (11), in which

the positive electrode includes a positive electrode active material layer, and

the melamine-based compound is entirely present in the positive electrode active material layer.

(13)

A positive electrode containing a melamine-based compound.

(14)

A battery pack including:

the battery according to any of (1) to (13) and a control unit that controls the battery.

(15)

An electronic device including the battery according to any of (1) to (13) and receiving supply of electric power from the battery.

(16)

An electric vehicle including:

the battery according to any of (1) to (13);

a conversion device that receives supply of electric power from the battery and converts the electric power into driving force for the electric vehicle; and

a control device that performs information processing related to control of the electric vehicle, based on information on the battery.

(17)

An electric storage device including the battery according to any of (1) to (13) and supplying electric power to an electronic device connected to the battery.

(18)

An electric power system including the battery according to any of (1) to (13) and receiving supply of electric power from the battery.

### DESCRIPTION OF REFERENCE SYMBOLS

11: Battery can
12, 13: Insulating plate
14: Battery cover
15: Safety valve mechanism
15A: Disk plate
16: Thermosensitive resistance element
17: Gasket
20: Wound electrode body
21: Positive electrode
21A: Positive electrode current collector
21B: Positive electrode active material layer
22: Negative electrode
22A: Negative electrode current collector
22B: Negative electrode active material layer
23: Separator
24: Center pin
25: Positive electrode lead
26: Negative electrode lead

1. A battery comprising a positive electrode, a negative electrode, and an electrolyte,
the positive electrode containing a melamine-based compound.

2. The battery according to claim 1, wherein the melamine-based compound contains at least one of melamine or a melamine derivative.

3. The battery according to claim 1, wherein the melamine-based compound is a melamine compound salt.

4. The battery according to claim 3, wherein the melamine compound salt contains an inorganic acid salt of an inorganic acid and melamine.

5. The battery according to claim 4, wherein the inorganic acid salt is at least one of melamine borate, melamine polyborate, melamine phosphate, melamine pyrophosphate, melamine metaphosphate, or melamine polyphosphate.

6. The battery according to claim 3, wherein the melamine compound salt contains an inorganic acid salt of an inorganic acid, melamine, melem, and melam.

7. The battery according to claim 6, wherein the inorganic acid salt is at least one of double salts such as melamine melem melam pyrophosphate, melamine melem melam phosphate, melamine melem melam metaphosphate, and melamine melem melam polyphosphate.

8. The battery according to claim 3, wherein the melamine compound salt contains an organic acid salt of an organic acid and melamine.

9. The battery according to claim 8, wherein the organic acid salt is melamine cyanurate.

10. The battery according to claim 1, wherein the melamine-based compound has a pyrolysis starting temperature of 250° C. or higher.

11. The battery according to claim 1, wherein
the positive electrode contains positive electrode active material particles, and
the melamine-based compound covers at least part of surfaces of the positive electrode active material particles.

12. The battery according to claim 1, wherein
the positive electrode includes a positive electrode active material layer, and
the melamine-based compound is entirely present in the positive electrode active material layer.

13. A positive electrode comprising a melamine-based compound.

14. A battery pack comprising:
the battery according to claim 1 and
a control unit that controls the battery.

15. An electronic device comprising the battery according to claim 1 and receiving supply of electric power from the battery.

16. An electric vehicle comprising:
the battery according to claim 1;
a conversion device that receives supply of electric power from the battery and converts the electric power into driving force for the electric vehicle; and
a control device that performs information processing related to control of the electric vehicle, based on information on the battery.

17. An electric storage device comprising the battery according to claim 1 and supplying electric power to an electronic device connected to the battery.

18. An electric power system comprising the battery according to claim 1 and receiving supply of electric power from the battery.
